(19) United States
(12) Patent Application Publication
(10) Pub. No.: US 2026/0065808 A1
(43) Pub. Date: Mar. 5, 2026

(54) EYE PHANTOM ASSEMBLY, A METHOD FOR MANUFACTURING THE SAME, AND AN EYE PHANTOM COMPRISING THE SAME

(71) Applicant: KOREA RESEARCH INSTITUTE OF STANDARDS AND SCIENCE, Daejeon (KR)

(72) Inventors: Sang Won LEE, Sejong-si (KR); Hyun Ji Lee, Daejeon (KR); II Doh, Daejeon (KR); Tae Geol Lee, Daejeon (KR)

(73) Assignee: KOREA RESEARCH INSTITUTE OF STANDARDS AND SCIENCE, Daejeon (KR)

(21) Appl. No.: 19/308,729

(22) Filed: Aug. 25, 2025

(30) Foreign Application Priority Data
Aug. 27, 2024 (KR) 10-2024-0115333

(51) Int. Cl. G09B 23/30

(52) U.S. Cl. CPC G09B 23/303

(57) ABSTRACT

Disclosed are an eye phantom assembly, a method for manufacturing the same, and an eye phantom including the same. The eye phantom assembly includes: a nerve fiber layer (NFL)-mimicking layer having superficial vascular channels formed to mimic a nerve fiber layer; a multilayer membrane-mimicking layer bonded to one surface of the NFL-mimicking layer and having a structure in which multiple layers with different scattering coefficients are stacked; an outer plexiform layer (OPL)-mimicking layer bonded to one surface of the multilayer membrane-mimicking layer and having deep vascular channels formed to mimic an outer plexiform layer; an outer membrane-mimicking layer bonded to one surface of the OPL-mimicking layer and formed to mimic the outer cell layer structure of the retina; and a choroid membrane-mimicking layer bonded to one surface of the outer membrane-mimicking layer and having choroidal vascular channels formed to mimic the choroid.

### TECHNICAL FIELD

The present disclosure relates to an eye phantom assembly for evaluating retinal angiographic images, a method for manufacturing the same, and an eye phantom including the same, and more specifically, to an eye phantom assembly for evaluating retinal images and retinal angiographic images, which is used to evaluate imaging medical devices for imaging the retina of the eye, such as an ophthalmic fundus camera (fundus photography), an optical coherence tomography (OCT) device, and a scanning laser ophthalmoscopy (SLO), and enables the evaluation of the performance of the imaging medical devices for retinal diagnosis in an easier and smoother manner by more closely mimicking the actual structure of the eye, as well as a method for manufacturing the same, and an eye phantom including the same.

### BACKGROUND ART

The retina of the human eye is a key tissue that detects light and determines vision. It is a very thin tissue with a thickness of less than 0.5 mm, and once damaged, it cannot be restored. Therefore, observing the retina in ophthalmic diseases and correctly and accurately pointing out lesions is considered a very important factor in disease treatment. A representative example of a retinal tomography instrument for diagnosing these ophthalmic diseases and checking the treatment progress is an optical coherence tomography, OCT) device.

Most retinal OCT devices currently used in hospitals and other practice settings are fourth-generation OCT products (SD-OCTs), which have significantly improved image quality compared to previous generation instruments and make it possible to acquire images of the 3D cross-sectional structure of the retina. OCT allows diagnosis or treatment progress monitoring by visualizing morphological changes in the retina or measuring the thickness in a specific area. Recently, the fifth-generation OCT product (OCT-A) equipped with the function of acquiring angiographic images from OCT images without contrast agent has been released after receiving US FDA approval in 2015. In addition, a multifunctional retinal imaging device that combines OCT technology and scanning laser ophthalmoscopy (SLO) technology has recently been commercialized, providing various retinal images.

The market for ophthalmic diagnostic devices is currently worth about $1.4 billion worldwide, and thereamong, the OCT market is known to be the largest. However, Korea currently imports almost all of the devices from overseas companies such as the United States, Germany and Japan, and it has been pointed out that the domestic OCT technology field is overly dependent on overseas technology. Accordingly, research and development efforts to develop domestic OCT devices have been made steadily.

However, there are the following problems in developing domestic OCT devices. In the case of ophthalmic OCTs imported into Korea, only electric/electromagnetic stability evaluation and laser stability evaluation are made, and the performance evaluation of the actual equipment, that is, the evaluation on how accurately retina images are observed, is not separately made upon import. That is, there is a problem in that it is still difficult to perform the systematic evaluation on OCT devices in Korea, and the process of checking and improving performance in the process of developing domestic OCT devices is not smoothly performed. Specifically, in order to obtain medical device certification after the development of the medical device product is completed, an evaluation through preclinical or clinical trials is necessarily conducted. However, since it is impossible to conduct tests on animals or humans in the process of product development or in performance evaluation to obtain medical device certification and a production process, it is very difficult to realize performance verification and improvement work in the device development process.

Of course, in order to solve these problems in the related art, a technology for acquiring images and evaluating performance using an eye phantom that mimics the eye of an actual animal or human instead of using the eye has been used. An eye phantom for evaluating the performance of a conventional OCT device comprises a multilayer film structure in which several layers are stacked by mimicking the structure of retinal tissue.

However, as described above, the fifth generation OCT device has the function of obtaining angiographic images from OCT images, and products combined with SLO also have the function of obtaining various fluorescence images. It is known that domestic OCT devices are also being developed to be able to realize these various functions. However, a conventional eye phantom merely mimics the multilayer structure of the retina, and has no structure corresponding to blood vessels formed in the retina. Therefore, it is impossible to obtain an image corresponding to an angiographic image from an OCT image of a conventional eye phantom, and thus there is a problem in that there is a limit to applying the conventional eye phantom to the development of the fifth-generation OCT device, and it is also impossible to acquire various fluorescence images that may be obtained from a multifunctional retinal imaging device.

The background art described above is technical information that the inventor has possessed for deriving embodiments of the present disclosure or acquired in the process of deriving embodiments of the present disclosure, and cannot necessarily be considered as an art disclosed to the general public prior to the filing of embodiments of the present disclosure.

### DISCLOSURE

### Technical Problem

To solve the above-described problems, the present disclosure provides an eye phantom assembly for evaluating retinal angiographic images and retinal fluorescence images, which can mimic even the vascular structure and layered structure of the retina more similarly to the actual structure of the retina than a conventional eye phantom, a method for manufacturing the same, and a method for manufacturing an eye phantom including the same.

### Technical Solution

An eye phantom assembly according to one embodiment of the present disclosure may include: a nerve fiber layer (NFL)-mimicking layer having superficial vascular channels formed in the form of microchannels to mimic a nerve fiber layer (NFL) among cell layers of the retina; a multilayer membrane-mimicking layer bonded to one surface of the NFL-mimicking layer and having a structure in which multiple layers with different scattering coefficients are stacked to mimic the multilayer cell layer structure of the retina; an outer plexiform layer (OPL)-mimicking layer bonded to one surface of the multilayer membrane-mimicking layer and having deep vascular channels formed in the form of microchannels to mimic an outer plexiform layer(OPL) among the cell layers of the retina; an outer membrane-mimicking layer bonded to one surface of the OPL-mimicking layer and formed to mimic the outer cell layer structure of the retina; and a choroid-mimicking layer bonded to one surface of the outer membrane-mimicking layer and having choroidal vascular channels formed in the form of microchannels to mimic the choroid.

According to one embodiment of the present disclosure, the eye phantom assembly may further include a transparent layer bonded to the other surface of the NFL-mimicking layer.

According to one embodiment of the present disclosure, a concave curved portion may be formed in the center of the NFL-mimicking layer, the multilayer membrane-mimicking layer, the OPL-mimicking layer, the outer membrane-mimicking layer, and the choroid-mimicking layer.

According to one embodiment of the present disclosure, the multilayer membrane-mimicking layer may have a structure in which a ganglion cell layer (GCL)-mimicking layer formed as a film having a scattering coefficient corresponding to that of a ganglion cell layer (GCL) among cell layers of the retina to mimic the GCL, an inner plexiform layer (IPL)-mimicking layer formed as a film having a scattering coefficient corresponding to that of an inner plexiform layer (IPL) among cell layers of the retina to mimic the IPL, and an inner nuclear layer (INL)-mimicking layer formed as a film having a scattering coefficient corresponding to that of an inner nuclear layer (INL) among cell layers of the retina to mimic the INL are sequentially stacked.

According to one embodiment of the present disclosure, the outer membrane-mimicking layer may have a structure in which a sequential stack of an outer nuclear layer (ONL)-mimicking layer formed as a film having a scattering coefficient corresponding to that of an outer nuclear layer (ONL) among the cell layers of the retina to mimic the ONL, an external limiting membrane (ELM)-mimicking layer formed as a film having a scattering coefficient corresponding to that of an external limiting membrane (ELM) among the cell layers of the retina to mimic the ELM, an inner segment photoreceptors (IS)-mimicking layer as a film having a scattering coefficient corresponding to that of inner segment photoreceptors (IS) among the cell layers of the retina to mimic the IS, a photoreceptor-mimicking layer formed as a film having a scattering coefficient corresponding to that of a photoreceptor among the cell layers of the retina to mimic the photoreceptor; an outer segment photoreceptors (OS)-mimicking layer formed as a film having a scattering coefficient corresponding to that of outer segment photoreceptors (OS) among the cell layers of the retina to mimic the OS, a Verhoeff membrane-mimicking layer formed as a film having a scattering coefficient corresponding to that of a Verhoeff membrane among the cell layers of the retina to mimic the Verhoeff membrane, and a retinal pigment epithelium (RPE)-mimicking layer as a film having a scattering coefficient corresponding to that of a retinal pigment epithelium (RPE) among the cell layers of the retina to mimic the RPE are sequentially stacked.

According to one embodiment of the present disclosure, the deep vascular channels of the OPL-mimicking layer may be formed as honeycomb-shaped channels.

According to one embodiment of the present disclosure, the RPE-mimicking layer may further include a fluorophore.

According to one embodiment of the present disclosure, the fluorophore may be lipofuscin.

According to one embodiment of the present disclosure, the eye phantom assembly may further include a through-channel that penetrates through the NFL-mimicking layer, the multilayer membrane-mimicking layer, the OPL-mimicking layer, the outer membrane-mimicking layer, and the choroid-mimicking layer to allow a blood-mimicking fluid to flow through the superficial vascular channels, the deep vascular channels, and the choroidal vascular channels.

An eye phantom according to one embodiment of the present disclosure may include: a lens comprising at least one lens to mimic a crystalline lens of an eye; the eye phantom assembly spaced apart from the lens along the axis of the lens such that the NFL-mimicking layer faces the lens; and a housing supporting the lens on one side and supporting the eye phantom assembly on the other side.

A method for manufacturing the eye phantom assembly according to one embodiment of the present disclosure may include: a first stacking step of forming a first stack by stacking the NFL-mimicking layer and the multilayer membrane-mimicking layer; a second stacking step of forming a second stack by stacking the OPL-mimicking layer and the outer membrane-mimicking layer; a third stacking step of forming a third stack by sequentially stacking the first stack, the second laminate, and the choroidal channel stack; and a fourth stacking step of stacking the retinal curvature-mimicking layer on the lower surface of the choroidal channel layer of the third stack.

According to one embodiment of the present disclosure, the method may further include, as a method for fabricating at least one of the NFL-mimicking layer, the OPL-mimicking layer, or the choroidal channel layer having formed therein the choroidal vascular channels of the choroid-mimicking layer: a light irradiation step of irradiating light for etching to the upper surface of a wafer through a mask having a reverse pattern shape of the shape of the microchannel; a reverse pattern formation step of forming a reverse pattern on the upper surface of the wafer by etching and removing the light-irradiated portion on the wafer; a raw material introduction step of introducing the raw material of at least one of the NFL-mimicking layer, the OPL-mimicking layer, or the choroidal channel layer; a substrate stacking step of stacking and pressing a substrate on the upper surface of the raw material introduced into the reverse pattern; a wafer separation step of curing the raw material in a state in which a pattern having a reverse shape of the reverse pattern is formed on the lower surface of the raw material and the substrate is adhered to the upper surface of the raw material, and separating the cured raw material from the wafer; and a substrate separation step of separating the raw material having a pattern of microchannels formed thereon from the substrate.

According to one embodiment of the present disclosure, the method may further include, as a method for fabricating at least one of the multilayer membrane-mimicking layer and the outer membrane-mimicking layer: a substrate upper surface coating step of coating the upper surface of a substrate with a coating agent; a raw material introduction step of introducing the raw material of at least one of the multilayer membrane-mimicking layer and the outer membrane-mimicking layer to the upper surface of the substrate; a raw material diffusion step of dispersing the raw material throughout the upper surface of the substrate by rotating the substrate; a substrate rotation stop step of stopping the rotation of the substrate when the raw material forms a predetermined thickness; and a film curing step of curing the raw material.

According to one embodiment of the present disclosure, the method may further include a mimicking layer formation step of forming multiple stacks having different scattering coefficients on the upper surface of the substrate by sequentially repeating the raw material introduction step, the raw material diffusion step, the substrate rotation stop step, and the film curing step.

According to one embodiment of the present disclosure, the raw material diffusion step may include varying the rotation speed of the substrate so that at least one of the plurality of multilayer membrane-mimicking layers and outer film-mimicking layers has a different thickness.

According to one embodiment of the present disclosure, the method may further include a substrate preparation step of preparing a wafer substrate.

According to one embodiment of the present disclosure, the method may include, as a method for fabricating the retinal curvature-mimicking layer, which is a portion of the choroid-mimicking layer excluding the choroidal channel layer: a plate preparation step of preparing a plate by forming a convex curved portion in the center of a flat plate formed in an engraved shape; a raw material introduction and curing step of introducing the raw material of the retinal curvature-mimicking layer into the plate and curing the raw material; and a plate separation step of separating the raw material of the retinal curvature-mimicking layer from the plate.

According to one embodiment of the present disclosure, the plate preparation step may include forming a concave curved portion in a direction opposite to the convex curved portion at a portion where one surface of the plate formed in the engraved shape and the convex curved portion contact each other.

According to one embodiment of the present disclosure, the plate preparation step may include forming protrusions, which serve as a predetermined reference point, on one surface of the plate formed in the engraved shape.According to one embodiment of the present disclosure, the method may include a pressing step of pressing the center of the eye phantom assembly.

### Advantageous Effects

The eye phantom of the present disclosure has a great effect in that it may mimic even the vascular structure and layered structure on the retina more similarly to the actual structure of the retina than conventional eye phantoms.

Thus, according to the present disclosure, the eye phantom of the present disclosure has a great effect in that it may be applied to a multifunctional retinal imaging medical device equipped with a function of obtaining three-dimensional cross-sectional structural images of the retina and angiographic images from OCT images and a function of obtaining various fluorescence images from SLO images, so that the performance of the device under development may be accurately evaluated. In particular, in the past, there was no way to properly evaluate the performance of a device under development because it was impossible to directly evaluate the performance using animals or people. However, according to the present disclosure, since the performance of a device under development may be evaluated as described above, there is a great industrial effect that allows the development of an OCT device to proceed much more smoothly. In addition, by allowing a solution containing a fluorophore to flow into the microchannels, it becomes possible to evaluate the performance of a fluorescence angiography fundus camera in an SLO device.

The effects obtainable from the invention are not limited to the effects mentioned above, and other effects not mentioned can be clearly understood by those skilled in the art to which the present disclosure pertains from the following description.

### BRIEF DESCRIPTION OF DRAWINGS

FIG. 1 shows exploded and assembled views of an eye phantom assembly 100 according to one embodiment of the present disclosure.

FIG. 2 shows an optical coherence tomography cross-sectional image of the eye phantom assembly 100 according to one embodiment of the present disclosure.

FIGS. 3 and 4 shows plan views and fluorescein fundus angiographic images, respectively, of an NFL-mimicking layer, an OPL-mimicking layer, and a choroid-mimicking layer, which are layers mimicking the retina and choroid, in the eye phantom assembly according to one embodiment of the present disclosure.

FIG. 5 shows photographs of a blood-mimicking fluid flowing through superficial vascular channels, deep vascular channels, and choroidal vascular channels in the eye phantom assembly according to one embodiment of the present disclosure.

FIG. 6 shows images of the eye phantom assembly according to one embodiment of the present disclosure, which includes lipofuscin.

FIG. 7 shows a side view of an eye phantom according to one embodiment of the present disclosure.

FIG. 8 shows an actual photograph of an eye phantom according to one embodiment of the present disclosure.

FIG. 9 shows a flow diagram of a method for fabricating an NFL-mimicking layer, an OPL-mimicking layer, or choroidal vascular channels of a choroid-mimicking layer in the eye phantom assembly according to one embodiment of the present disclosure.

FIG. 10 shows a flow diagram of a method for fabricating a multilayer membrane-mimicking layer and an outer membrane-mimicking layer in the eye phantom assembly according to one embodiment of the present disclosure.

FIG. 11 shows a plan view and a side view of a plate in a method for fabricating a retinal curvature-mimicking layer among the elements of a choroid-mimicking layer in the eye phantom assembly according to one embodiment of the present disclosure.

FIG. 12 shows a flow diagram of a stacking step and a pressing step in a method for fabricating the eye phantom assembly according to one embodiment of the present disclosure.

### MODE FOR INVENTION

The present disclosure will be clear by referring to the embodiments described below in detail in conjunction with the accompanying drawings. However, the present disclosure is not limited to the embodiments disclosed below and may be embodied in a variety of different forms. Rather, these embodiments disclosed herein are provided so that the present disclosure will be thorough and complete, and will fully convey the spirit of the present disclosure to those skilled in the art. The present disclosure will be defined only by the scope of the appended claims. Meanwhile, the terms used herein are for the purpose of describing embodiments and are not intended to limit the present disclosure.

Throughout the present specification, singular forms also include plural forms unless the context clearly indicates otherwise.

Throughout the present specification, the terms “includes” and/or “including” specify the presence of stated components, steps, operations and/or elements, but do not exclude the presence or addition of one or more other components, steps, operations and/or elements. These terms mean that any part does not exclude other components, but may further include other components, unless specifically stated otherwise.

In addition, terms such as "...unit" used throughout the present specification mean a unit that processes at least one function or operation, which may be implemented in hardware or software or a combination of hardware and software.

In addition, throughout the present specification, it is to be understood that when any part is referred to as being “connected” to another part, it may be connected “directly” to the other part or “intervening elements” may be present.

Hereinafter, the present disclosure will be described in more detail.

Eye Phantom Assembly and Eye Phantom Including the Same

An eye phantom assembly 100 according to one embodiment of the present disclosure may include an NFL-mimicking layer 110, a multilayer membrane-mimicking layer 120, an OPL-mimicking layer 130, an outer membrane-mimicking layer 140, and a choroid-mimicking layer 150. The eye phantom assembly has a shape in which layers mimicking an actual eye are stacked, which makes it possible to obtain an angiographic image similar to that of an actual eye when testing the performance of a fifth-generation OCT device. In particular, the present disclosure is characterized by specifically mimicking an NFL-mimicking layer 110, an OPL-mimicking layer 130, an outer membrane-mimicking layer 140, and a choroid-mimicking layer 150, which was not achieved in the related art.

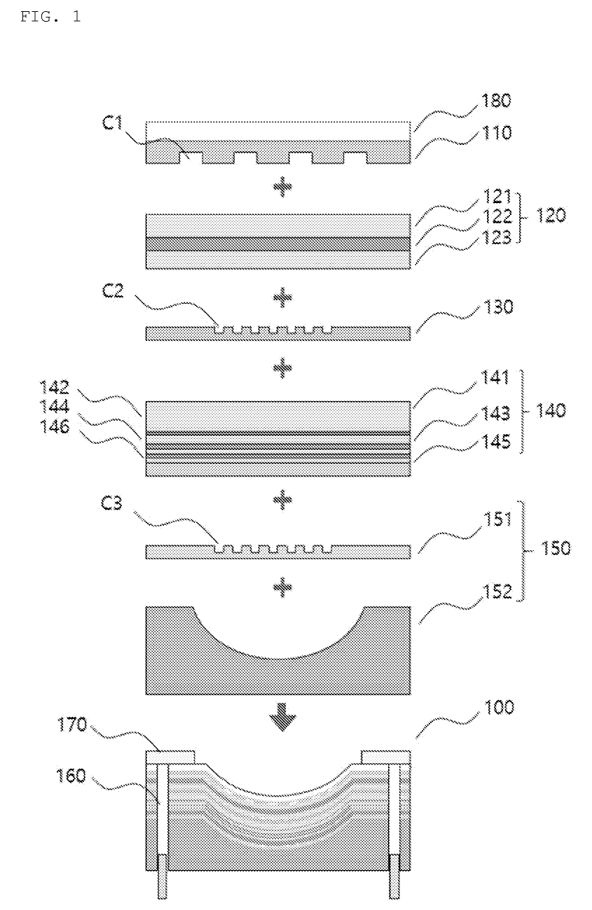

FIG. 1 shows exploded and assembled views of an eye phantom assembly 100 according to one embodiment of the present disclosure.

Referring to FIG. 1, the NFL-mimicking layer 110 is configured to mimic the nerve fiber layer (NFL) among the cell layers of the retina, and the NFL-mimicking layer 110 may include superficial vascular channels (C1) formed in the form of microchannels that mimics the blood vessels of an actual eye.

In particular, in the present disclosure, the eye phantom assembly may further include a transparent layer 180 on the NFL-mimicking layer 110. In a conventional art, since the superficial vascular channels (C1) in the NFL-mimicking layer 110 are formed by etching, the actual NFL-mimicking layer 110 could only be fabricated to have a thickness of about 100 μm. However, in the present disclosure, in order to fabricate the NFL-mimicking layer 110 to a thickness of about 40 μm, a separate transparent layer 180 is formed, which has the advantage of being able to withstand external pressure while mimicking the thickness of an actual NFL.

The multilayer membrane-mimicking layer 120 is configured to mimic the multilayer cell layer structure of the retina and is bonded to one surface of the NFL-mimicking layer 110. The multilayer membrane-mimicking layer 120 is characterized by having a structure in which multiple layers with different scattering coefficients are stacked.

In particular, the multilayer membrane-mimicking layer 120 may be composed of a GCL-mimicking layer 121, an IPL-mimicking layer 122, and an INL-mimicking layer 123 to mimic an actual eye.

The GCL-mimicking layer 121, the IPL-mimicking layer 122, and the INL-mimicking layer 123 are configured to mimic the ganglion cell layer, the inner plexiform layer (IPL), and the inner nuclear layer (INL), respectively, which are the retinal cell layers of an actual eye. The layers may be sequentially stacked in the form of films having different scattering coefficients.

The OPL-mimicking layer 130 is configured to mimic the outer plexiform layer (OPL) among the cell layers of the retina, and the OPL-mimicking layer 130 may include deep vascular channels (C2) formed in the form of microchannels mimicking the blood vessels of an actual eye.

The outer membrane-mimicking layer 140 is configured to mimic the outer cell layer structure of the retina and is bonded to one surface of the OPL-mimicking layer 130. Unlike conventional technologies, the present disclosure more specifically mimics an actual retina by including the outer membrane-mimicking layer 140.

In the eye phantom assembly 100 according to the present disclosure, the outer membrane-mimicking layer 140 may be composed of an ONL-mimicking layer 141, an ELM-mimicking layer 142, an IS-mimicking layer 143, a photoreceptor-mimicking layer 144, an OS-mimicking layer 145, a Verhoeff membrane-mimicking layer 146, and an RPE-mimicking layer 147. The ONL-mimicking layer 141, the ELM-mimicking layer 142, the IS-mimicking layer 143, the photoreceptor-mimicking layer 144, the OS-mimicking layer 145, the Verhoeff membrane-mimicking layer 146, and the RPE-mimicking layer 147 are configured to mimic the outer cell layers of the actual retina, namely the outer nuclear layer (ONL), external limiting membrane (ELM), inner segment photoreceptors (IS), photoreceptor, outer segment photoreceptors (OS), Verhoeff membrane, and retinal pigment epithelium (RPE), respectively. The layers may be sequentially stacked in the form of films having different scattering coefficients.

The choroid-mimicking layer 150 is configured to mimic the choroid and is bonded to one surface of the outer membrane-mimicking layer 140. The choroid-mimicking layer 150 may include a choroidal channel layer 151 including choroidal vascular channels (C3) formed in the form of microchannels to mimic the choroid, and a retinal curvature-mimicking layer 152 which is a choroidal portion excluding the choroidal channel layer 151.

In the eye phantom assembly 100 according to one embodiment of the present disclosure, the NFL-mimicking layer 110, the multilayer membrane-mimicking layer 120, the OPL-mimicking layer 130, the outer membrane-mimicking layer 140, and the choroid-mimicking layer 150 are sequentially stacked on one another, and these layers may be bonded to each other by plasma bonding.

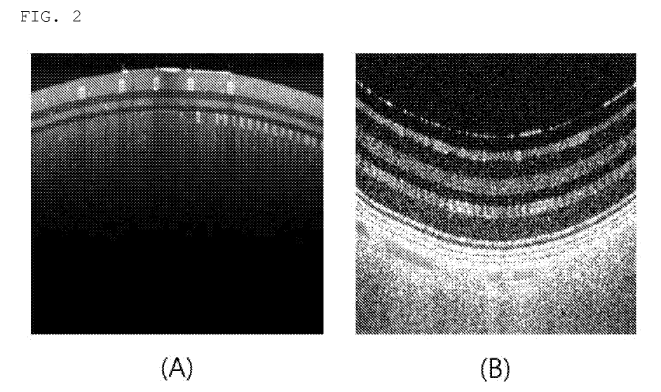

Here, the eye phantom assembly 100 according to the present disclosure is characterized by having a predetermined curvature in order to more accurately mimic the actual structure of the retina. FIG. 2 shows an optical coherence tomography (OCT) cross-sectional image of the eye phantom assembly 100 according to one embodiment of the present disclosure. As shown in FIG. 2(A), a conventional eye phantom is photographed in a convex shape, unlike the structure of an actual retina, because the multiple layers of the eye phantom are stacked in a planar fashion. However, the eye phantom assembly 100 according to one embodiment of the present disclosure may be photographed in a concave shape like the structure of an actual retina, as shown in FIG. 2(B).

This is because, as shown in FIG. 1, the central portion of the NFL-mimicking layer 110, the multilayer membrane-mimicking layer 120, the OPL-mimicking layer 130, the outer membrane-mimicking layer 140, and the choroid-mimicking layer 150 in the eye phantom assembly 100 of the present disclosure is curved in a concave shape. As a result, a photographing result very similar to that of an actual eye may be obtained.

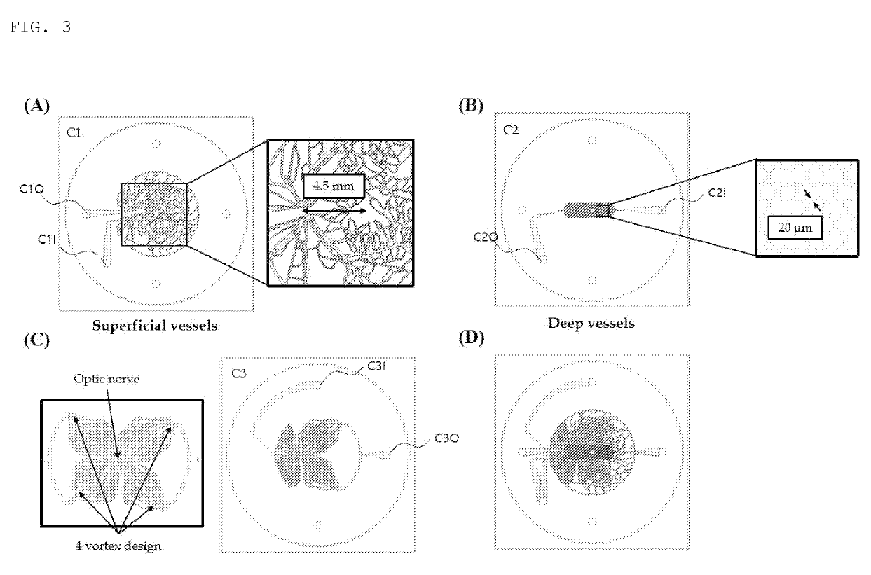

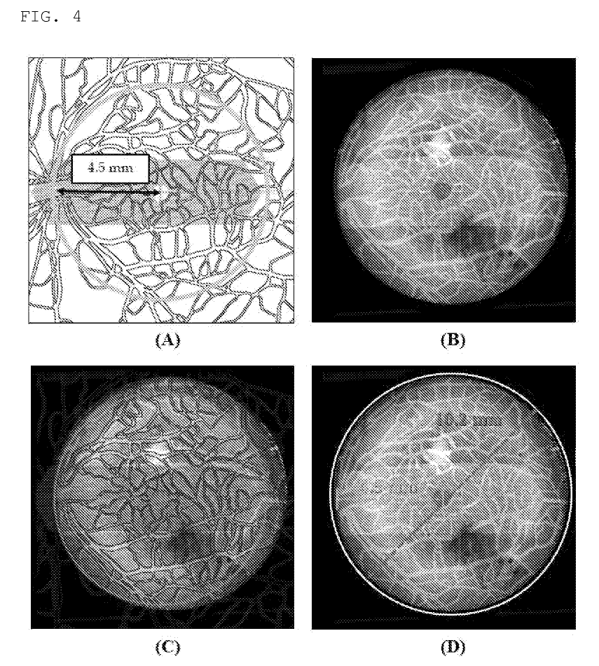

FIGS. 3 and 4 shows plan views and fluorescein fundus angiographic images, respectively, of the NFL-mimicking layer 110, the OPL-mimicking layer 130, and the choroid-mimicking layer150, which are layers mimicking the retina and choroid, in the eye phantom assembly 100 according to one embodiment of the present disclosure.

Referring to FIGS. 3(A), 3(B), and 3(C), the respective layers can specifically mimic the vascular structures, formed in the NFL, OPL, and choroid in an actual eye, by the superficial vascular channels (C1), the deep vascular channels (C2), and the choroidal vascular channels (C3). When the layers are photographed overlapping each other, a blood vessel structure similar to that on an actual retinal image of the eye can be confirmed, as shown in FIG. 3(D). In particular, referring to FIG. 3(C), the choroidal vascular channels (choroidal blood vessels, C3) may include all four vortex veins. The vortex veins are blood vessels that spread out radially and serve to drain blood from the cornea and choroid of the eye. The present disclosure has the advantage of being able to solve the existing problem of not being able to photograph all of the vortex veins.

Referring to (B) of FIG. 3, in the present disclosure, the deep vascular channels (C2) of the OPL-mimicking layer 130 is characterized by being formed as honeycomb-shaped channels to mimic the capillaries of the OPL. The deep vascular channels (C2) may be formed to have a channel width of about 20 μm

Referring to FIG. 4(A), the eye phantom assembly 100 according to one embodiment of the present disclosure may measure the field of view (FOV) so that the fovea is located at a location 4.5 mm away from the optic nerve area. FIG. 4(B) shows an OCT fundus image of a retinal phantom projected onto the x-y plane in a 3D volumetric OCT image. Here, FIG. 4(C) shows the superposition of FIGS. 4(A) and 4(B).

In order to allow a blood-mimicking fluid to flow through the superficial vascular channels (C1), deep vascular channels (C2), and choroidal vascular channel (C3) formed in the NFL-mimicking layer 110, the OPL-mimicking layer 130, and the choroid-mimicking layer 150, respectively, a separate through-channel that allows the blood-mimicking fluid to flow to each layer is required. Referring to FIG. 1, a through-channel 160 that penetrates through the NFL-mimicking layer 110, the multilayer membrane-mimicking layer 120, the OPL-mimicking layer 130, the outer membrane-mimicking layer 140, and the choroid-mimicking layer 150 is shown. This through-channel 160 may be connected to an inlet and an outlet (not shown) so that a blood-mimicking fluid may be introduced into and discharged from the eye phantom assembly 100. In addition, the through-channel 160 may be configured to penetrate through each layer so that the blood-mimicking fluid may flow to each layer within the eye phantom assembly 100. In addition, in order to prevent the blood-mimicking fluid from leaking from the eye phantom assembly 100, a sealing layer 170 may be formed on the NFL-mimicking layer 110 through which the through-channel 160 penetrates. The sealing layer 170 may have a donut shape and may be coupled to the upper surface of the transparent layer 180 by plasma bonding.

The flow of a blood-mimicking fluid flowing in the eye phantom assembly 100 according to one embodiment of the present disclosure is as follows.

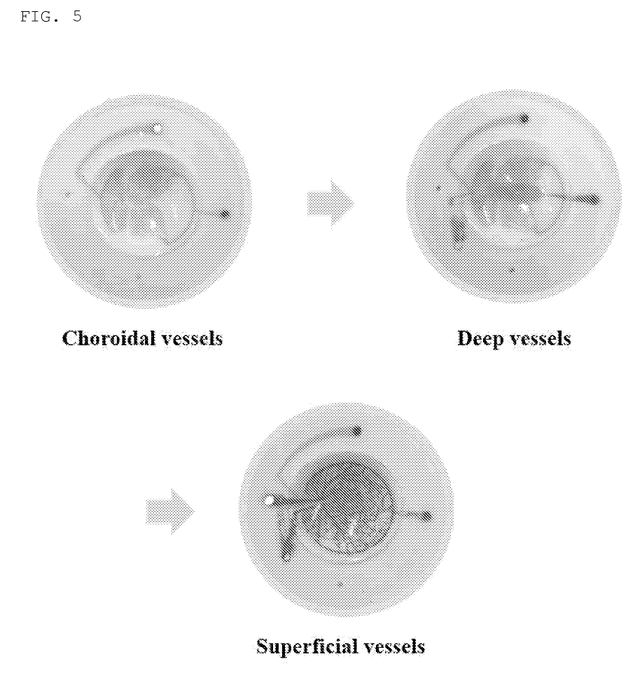

FIG. 5 shows photographs of a blood-mimicking fluid flowing through the superficial vascular channels (C1), the deep vascular channels (C2), and the choroidal vascular channels (C3) in the eye phantom assembly 100 according to one embodiment of the present disclosure. Referring to FIGS. 3 and 5, the blood-mimicking fluid introduced into a choroidal vascular channel inlet (C3I) flows through the choroidal vascular channels (C3) and exits from a choroidal vascular channel outlet (C3O). Thereafter, the blood-mimicking fluid may flow through the through-channel 160 communicating with the choroidal vascular channel outlet (C3O), enter a deep vascular channel inlet (C2I), flow through the deep vascular channel (C2), and exit through a deep vascular channel outlet (C2O). Thereafter, the blood-mimicking fluid may flow through the through-channel 160 communicating with a deep vascular channel outlet (C2O), enter a superficial vascular channel inlet (C1I), and flow through the superficial vascular channels (C1) and exit through a superficial vessels channel outlet (C1O). The blood-mimicking fluid may flow in this cycle, and may also flow in a direction opposite to the direction of the flow.

Meanwhile, the eye phantom assembly 100 according to one embodiment of the present disclosure may further include a fluorophore in the RPE-mimicking layer 146. The retinal pigment epithelium of an actual eye contains lipofuscin, a fluorophore. Lipofuscin is a waste product related to cell aging, accumulates in RPE cells, and is characterized by autofluorescence. Due to these properties, the condition of the RPE layer of an actual eye may be noninvasively evaluated through fundus autofluorescence (FAF), but a conventional eye phantom does not contain lipofuscin, and thus has a problem in that the RPE layer cannot be photographed. The present disclosure has the advantage of allowing for easier identification of health status by visualizing the accumulation status of lipofuscin by including a fluorophore, more specifically lipofuscin, in the RPE-mimicking layer 146.

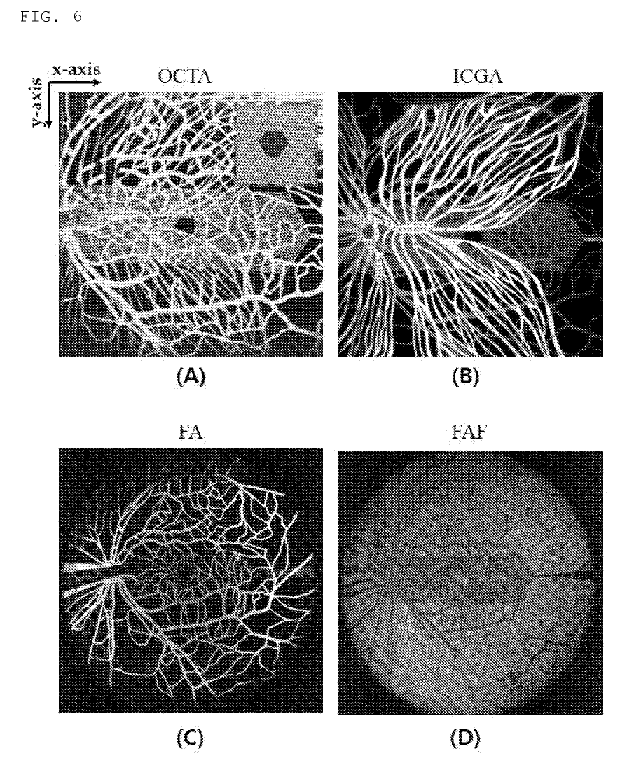

FIG. 6 shows images of the eye phantom assembly 100 according to one embodiment of the present disclosure, which includes lipofuscin. Referring to FIG. 6, an OCTA image (FIG. 6(A)) and a SLO image (FIGS. 6(B), (C), and (D)) may be obtained from one eye phantom assembly 100. In particular, FIG. 6(B) is an ICGA image, FIG. 6(C) is an FA image, and FIG. 6(D) is an FAF image. FIGS. 6(B) and (C) correspond to fluorescence images obtained by adding ICG and fluorescein fluorescent solution to each channel, and FIG. 6(D) corresponds to a fluorescence image expressed by lipofuscin.

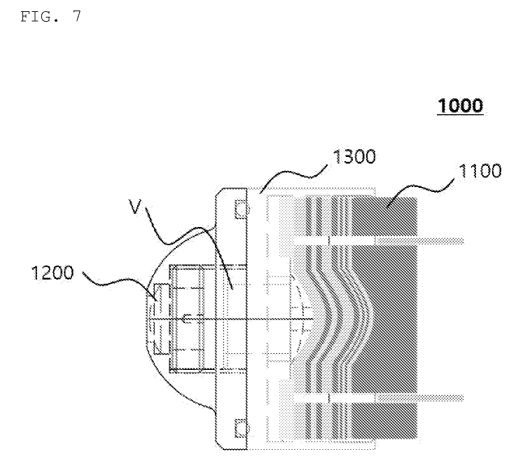

The ocular phantom assembly 100 according to the present disclosure mentioned above may form an eye phantom 1000 by being combined with additional elements. FIG. 7 shows a side view of an eye phantom according to one embodiment of the present disclosure.

As described above, conventional eye phantoms are of a type that only mimics the multilayer cell layer structure of the retina. However, the eye phantom of the present disclosure has the advantage of being able to mimic all of the blood vessels, layered structure, and curvature structure of the retina of an actual eye.

Referring to FIG. 7, an eye phantom 1000 according to one embodiment of the present disclosure may include a lens 1200, an eye phantom assembly 1100, and a housing 1300.

The lens 1200 is composed of at least one lens 1200 to mimic the crystalline lens of the eye. In FIG. 7, the lens 1200 is depicted as being composed of one lens, but the lens 1200 may also be composed of a stack of multiple lenses as needed.

The eye phantom assembly 1100 includes all of the elements of the eye phantom assembly 1100 according to the embodiment of the present disclosure described above, and may be disposed along the axis of the lens 1200 so that the NFL-mimicking faces the lens 1200. That is, the concave surface of the eye phantom assembly 1100 may face the lens 1200.

The lens 1200 and the eye phantom assembly 1100 are spaced apart from each other, but a space (V) for accommodating a vitreous body-mimicking fluid may be provided between the lens 1200 and the eye phantom assembly 1100. Here, the vitreous body-mimicking fluid may be, for example, water or a vitreous solution.

The eye phantom may further include a housing 1300 that supports the lens 1200 and the elements of the eye phantom assembly 1100. The shape of the housing 1300 is not particularly limited as long as it is a shape that may support the lens 1200 and the eye phantom assembly 1100, similar to the inside of an actual eye.

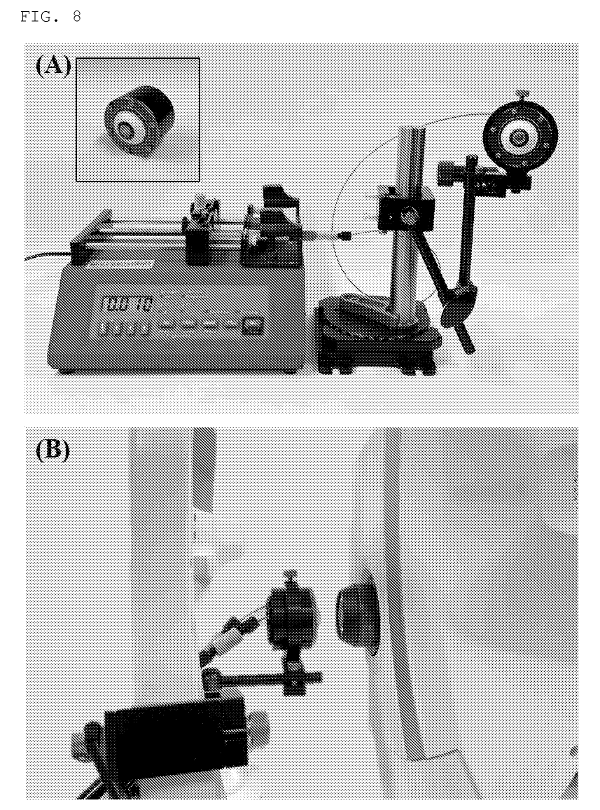

FIG. 8 shows an actual photograph of the eye phantom 100 according to one embodiment of the present disclosure.

Referring to FIG. 8(A), the eye phantom 1000 may further include a flow pump in the through-channel 160 to control the flow rate of the blood-mimicking fluid flowing into and out of the eye phantom assembly 1100. Referring to FIG. 8(B), the eye phantom 1000 may be installed on a support of a clinical ophthalmic imaging device.

### Method for Manufacturing Eye Phantom Assembly 100

The method for manufacturing the eye phantom assembly 100 according to one embodiment of the present disclosure corresponds to a specific method for manufacturing a shape including all of the elements of the eye phantom assembly 100 according to one embodiment of the present disclosure described above. A more detailed description is as follows.

A method for fabricating the NFL-mimicking layer 110, the OPL-mimicking layer 130, or the choroidal channel layer 151 having formed therein the choroidal vascular channels C3 of the choroid-mimicking layer 150, which is a layer that mimics the retina and/or the choroid, in the eye phantom assembly 100 according to one embodiment of the present disclosure, may include a light irradiation step, an reverse pattern formation step, a raw material introduction step, a substrate stacking step, a wafer separation step, and a substrate separation step.

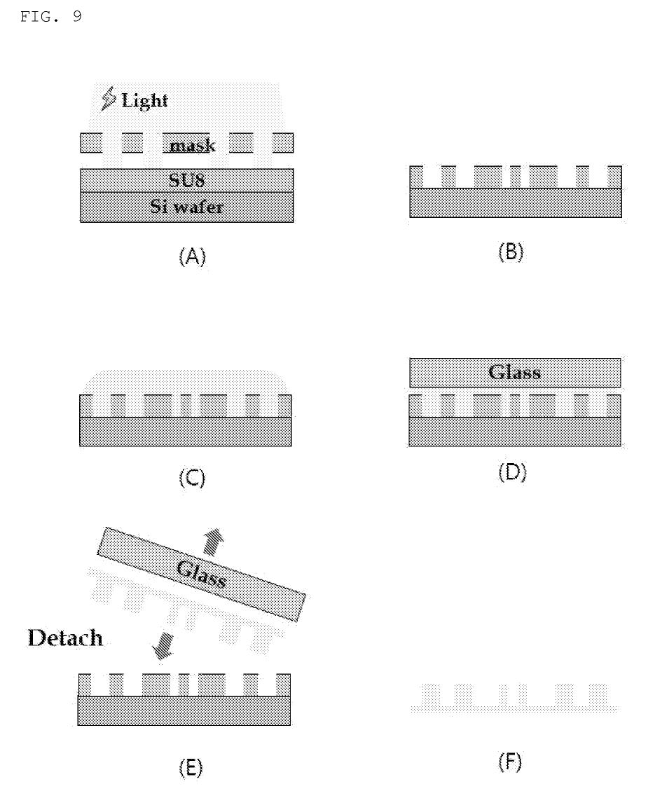

FIG. 9 shows a flow diagram of a method for fabricating the NFL-mimicking layer 110, the OPL-mimicking layer 130, or the choroidal channel layer 151 in the eye phantom assembly 100 according to one embodiment of the present disclosure.

As shown in FIG. 9(A), in the light irradiation step, light for etching may be irradiated to the upper surface of a wafer through a mask having a reverse pattern shape of the microchannel shape. For example, if an NFL-mimicking portion is to be fabricated, a reverse pattern of the superficial vascular channels (C1) may be formed on the mask. That is, after forming a traverse pattern of the channel shape on the mask according to the features of the mimicking portion, light for etching may be irradiated toward the mask and the upper surface of the wafer for patterning.

As shown in FIG. 9(B), in the reverse pattern formation step, the light-irradiated portion on the wafer may be removed by etching, thereby forming a reverse pattern on the upper surface of the wafer.

In the raw material introduction step, as shown in FIG. 9(C), a raw material may be introduced into the reverse pattern. That is, the raw material for fabricating the mimicking portion to be fabricated is introduced, and the raw material of one of the NFL-mimicking layer 110, the OPL-mimicking layer 130, or the choroidal channel layer 151 may be introduced. Here, the raw material may be a mixture of a curable resin and a scattering agent. In one embodiment, the curable resin may be polydimethylsiloxane (PDMS) and the scattering agent may be TiO₂.

As shown in FIG. 9(D), in the substrate stacking step, a substrate may be stacked and pressed on the upper surface of the raw material introduced into the reverse pattern. If the raw material is a mixture of a curable resin and a scattering agent as described above, it is in a gel state before being cured. Thus, in this case, when the substrate is stacked and pressed, the raw material may be well dispersed throughout the wafer having the reverse pattern formed thereon. The thickness of the raw material may be controlled according to the weight being pressed. Meanwhile, in order to easily separate the raw material from the substrate later, a substrate lower surface coating step of coating the lower surface of the substrate with a coating agent may be performed before the substrate stacking step.

As shown in FIG. 9(E), in the wafer separation step, in a state in which a pattern having a reverse shape of the reverse pattern is formed on the lower surface of the raw material and the upper surface of the raw material is attached to the substrate, the raw material may be cured and separated from the wafer. In this case, if the raw material is composed of PDMS as described above, the PDMS has a property of being cured by heat, and thus may be cured by heating using a heating device. Alternatively, if the raw material is composed of a photocurable resin, it may be cured by irradiation with light, etc. The curing process may be appropriately selected depending on the type of raw material.

As shown in FIG. 9(F), in the substrate separation step, the raw material having the microchannel patterns formed thereon may be separated from the substrate. In actual cases, there may be a surplus portion because the mimicking portion is made slightly larger than the desired size, and the through-channel 160 may not be created in this state. Therefore, after the substrate separation step, a surplus removal step of removing the surplus portion by cutting from the raw material having the microchannel patterns formed thereon may be performed.

A method for fabricating at least one of the multilayer membrane-mimicking layer 120, the outer membrane-mimicking layer 140, or the transparent layer 180 in the eye phantom assembly 100 according to one embodiment of the present disclosure may include a substrate upper surface coating step, a raw material introduction step, a raw material diffusion step, a substrate rotation stop step, and a film curing step.

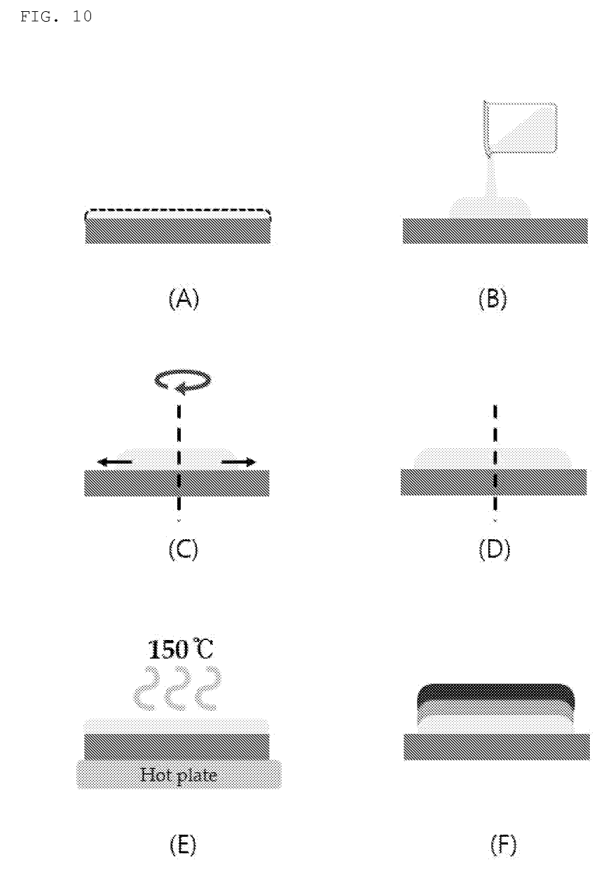

FIG. 10 shows a flow diagram of a method for fabricating at least one of the multilayer membrane-mimicking layer 120, the outer membrane-mimicking layer 140, or the transparent layer 180 in the eye phantom assembly 100 according to one embodiment of the present disclosure.

In the substrate upper surface coating step, as shown in FIG. 10(A), the upper surface of a substrate may be coated with a coating agent. The coating agent is intended to facilitate separation from the substrate after the fabrication of at least one of the multilayer membrane-mimicking layer 120, the outer membrane-mimicking layer 140, or the transparent layer 180 is completed.

Here, a substrate preparation step of preparing a wafer substrate as a substrate may be further included. Unlike conventional substrates, a more precise process needs to be performed in order to fabricate at least one of the multilayer membrane-mimicking layer 120, the outer membrane-mimicking layer 140, or the transparent layer 180 to have a smaller thickness. Therefore, in the present disclosure, a wafer substrate is prepared as the substrate, so that the thickness of the fine mimicking layer may be more precisely controlled.

As shown in FIG. 10(B), in the raw material introduction step, the raw material of any one or more of the multilayer membrane-mimicking layer 120, the outer membrane-mimicking layer 140, or the transparent layer 180 may be introduced to the upper surface of the substrate. In one embodiment, the raw material may be a mixture of a curable resin and a scattering agent. The curable resin may be polydimethylsiloxane (PDMS) and the scattering agent may be TiO₂.

As shown in FIG. 10(C), in the raw material diffusion step, the raw material may be dispersed throughout the upper surface of the substrate by rotating the substrate. If the raw material is a mixture of a curable resin and a scattering agent as described above, it is in a gel state before being cured. Thus, in this case, when the substrate rotates quickly, the raw material may be easily dispersed by centrifugal force. In addition, in this process, an overall uniform thickness may be formed. Of course, the edges may have a slightly uneven thickness, but they may be removed by cutting later, and a very elaborate operation is not required.

In particular, in the raw material diffusion step, the layers may be formed to have different thicknesses by varying the rotation speed of the substrate. More specifically, by varying the rotation speed of the substrate depending on the viscosity of the raw material, the thicknesses of the layers included in at least one of the multilayer membrane-mimicking layer 120, the outer membrane-mimicking layer 140, or the transparent layer 180 may be controlled differently from each other.

As shown in FIG. 10(D), in the substrate rotation stop step, the rotation of the substrate may be stopped when the raw material forms a predetermined thickness. Here, the “predetermined thickness” may be appropriately determined according to the layer currently being fabricated. In addition, by varying the time for stopping the rotation of the substrate, the thicknesses of the layers included in at least one of the multilayer membrane-mimicking layer 120, the outer membrane-mimicking layer 140, or the transparent layer 180 may be controlled differently from each other.

As shown in FIG. 10(E), in the film curing step, the multilayer film raw material may be cured. At this time, if the raw material is PDMS as described above, it has the property of being cured by heat, and thus may be cured by heating using a heating device such as a hot plate. Of course, if the raw material is composed of a photocurable resin, it may be cured by irradiation with light. Thus, the process for curing may be appropriately selected depending on the type of raw material.

As described above, when the raw material introduction step, the raw material diffusion step, the substrate rotation stop step, and the film curing step are performed once, one film is fabricated. By sequentially repeating these steps, multiple stacks may be formed on the upper surface of the substrate, as shown in FIG. 10(F). As described above, the ratio between the curable resin and scattering agent of the raw materials may be appropriately determined depending on which layer is currently being fabricated, and as a result, a stack of multiple layers having different scattering coefficients may be fabricated. The fabrication of the mimicking layer may be completed by appropriately cutting a stack of multiple layers having different scattering coefficients and forming the through-channel 160 that penetrates through at least one of the multilayer membrane-mimicking layer 120, the outer membrane-mimicking layer 140, or the transparent layer 180 at an appropriate location.

A method for fabricating the retinal curvature-mimicking layer 152 among the elements of the choroid-mimicking layer 150 in the eye phantom assembly 100 according to one embodiment of the present disclosure may include a plate preparation step, a raw material introduction and curing step, and a plate separation step.

For reference, as described above, the choroid-mimicking layer 150 may be composed of the choroidal channel layer 151 having choroidal vascular channels (C3) formed therein and the retinal curvature-mimicking layer 152. Thus, the choroidal channel layer 151 and the retinal curvature-mimicking layer 152 may be fabricated separately and bonded, or fabricated integrally and bonded. Hereinafter, a method of fabricating the retinal curvature-mimicking layer 152 by fabricating the choroidal channel layer 151 and the retinal curvature-mimicking layer 152 separately and combining them will be described.

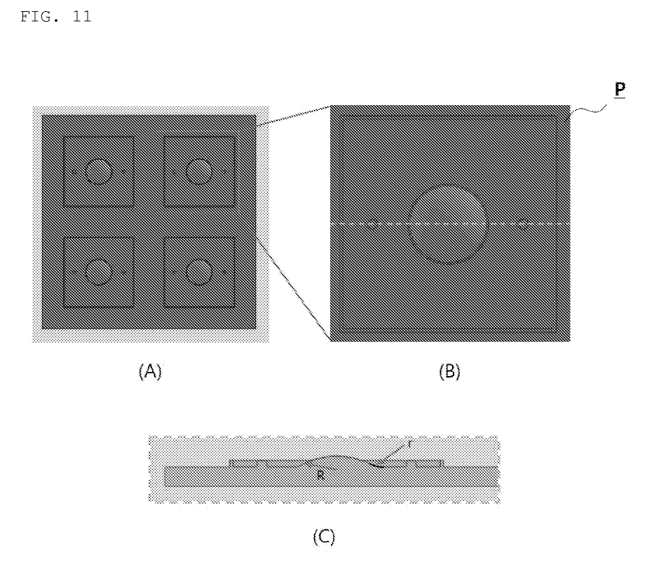

In the plate preparation step, a plate (P) on which the shape of the raw material to be realized may be prepared. FIG. 11 shows a plan view and a side view of a plate in a method for fabricating the retinal curvature-mimicking layer 152 among the elements of the choroid-mimicking layer 150 in the eye phantom assembly 100 according to one embodiment of the present disclosure. Referring to FIG. 11, the plate (P) may be formed flat, but may be engraved so that the raw material may be introduced thereinto. However, the plate (P) is characterized by having a convex curved portion formed in the center. This is to form a concave curved portion in the center of the eye phantom assembly 100.

Here, at a portion (r) where the flat surface of the plate (P) contacts the convex curved portion formed in the plate (P), a concave curved portion may be formed in a direction opposite to the convex curved portion. This means that the concave curved portion is formed to be rounded at the portion (r) where the plate (P) contacts the convex curved portion. This is to ensure better bonding between the mimicking layers in a subsequent stacking step despite the presence of the curved portion.

The material, size, and R value of the convex curved portion of the plate (P) are not particularly limited. In one embodiment, the plate (P) may be made of aluminum, and the R value of the convex curved portion may be 11.5 mm.

In addition, the plate (P) may include some protrusions. These protrusions serve as reference points on one surface of the plate (P) formed in the engraved shape, thereby making it easier to bond multiple mimicking layers. The shape and number of the protrusions are not particularly limited.

In the raw material introduction and curing step, the raw material of the retinal curvature-mimicking layer 152 may be introduced into the plate (P) formed in the engraved shape and then cured. Here, in one embodiment, the raw material may be a mixture of a curable resin and a scattering agent. The curable resin may be polydimethylsiloxane (PDMS) and the scattering agent may be TiO₂.

In the plate separation step, the raw material may be separated from the plate (P) in a state where a concave curved portion is formed in the center of the cured retinal curvature-mimicking layer 152. If necessary, it may include a concave curved portion in a direction opposite to the convex curved portion at a portion where the convex curved portion and the plane of the plate (P) contact each other, and may further include a plurality of protrusions.

The method may further include a stacking step of sequentially stacking the NFL-mimicking layer 110, the multilayer membrane-mimicking layer 120, the OPL-mimicking layer 130, the outer membrane-mimicking layer 140, and the choroidal channel layer 151 and retinal curvature-mimicking layer 152 of the choroid-mimicking layer 150, all of which are fabricated by the above-described method. In addition, the method may further include a pressing step of pressing and bonding the stacked mimicking layers.

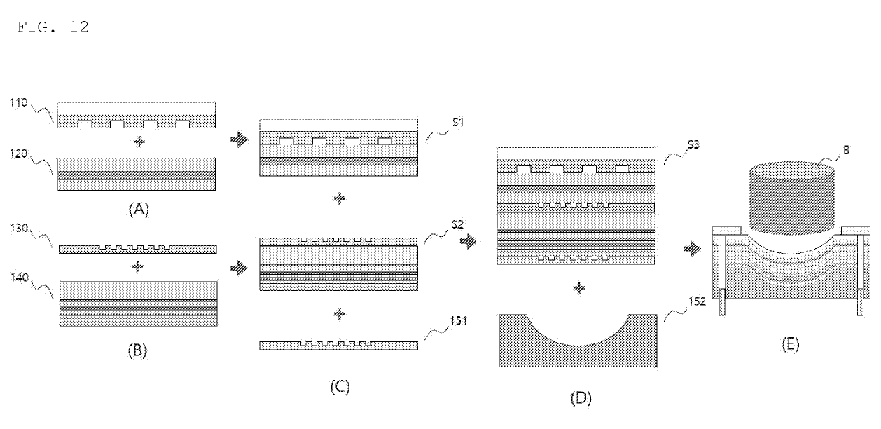

FIG. 12 shows a flow diagram of a stacking step and a pressing step in a method for fabricating the eye phantom assembly 100 according to one embodiment of the present disclosure.

Referring to FIG. 12(A), a first stack S1 may be formed by stacking the NFL-mimicking layer 110 and the multilayer membrane-mimicking layer 120. Referring to FIG. 12(B), a second stack S2 may be formed by stacking the OPL-mimicking layer 130 and the outer membrane-mimicking layer 140. Referring to FIG. 12(C), a third stack S3 may be formed by sequentially stacking the first stack S1, the second stack S2, and the choroidal channel layer 151. Finally, referring to FIG. 12(D), the retinal curvature-mimicking layer 152 may be stacked on the lower surface of the choroidal channel layer 151 in the third stack S3. Here, the central portion of the stack may also have a concave shape due to the concave curved portion formed in the retinal curvature-mimicking layer 152.

In addition, the eye phantom assembly 100 may be pressed in the up-down direction so that the layers may be more easily bonded in a concave shape. The pressing device used may be a bar (B) having a convex shape corresponding to the concave shape. In this case, there is an advantage in that the bonding between the layers may be more easily achieved. In particular, the concave shape may be formed in consideration of the curvature of the bar (B) and the curvature of the concave curved portion formed in the center of the stack.

In conclusion, the eye phantom assembly 100, the method for manufacturing the same, and the eye phantom including the same according to one embodiment of the present disclosure may more closely mimic the structure of an actual retina than conventional ocular phantoms by including microchannels with various shapes corresponding to the blood vessel structures formed in an actual retina and the structure of an actual layered structure as described above. Accordingly, the eye phantom of the present disclosure may be applied to the development process of a fifth-generation OCT device equipped with the function of acquiring angiographic images from OCT images, so that the performance of the device under development may be accurately evaluated. In addition, there is an advantage in that they may be used in SLO and other ophthalmic imaging systems.

Although the present disclosure has been described above by way of limited embodiments, the present disclosure is not limited thereto. It should be understood that the present disclosure can be variously changed and modified by those skilled in the art without departing from the technical spirit of the present disclosure and the range of equivalents to the appended claims.

### REFERENCE SIGN LIST

100, 1100: eye phantom assembly

110: NFL-mimicking layer

120: multilayer membrane-mimicking layer

121: GCL-mimicking layer

122: IPL-mimicking layer

123: INL-mimicking layer

130: OPL-mimicking layer

140: outer membrane-mimicking layer

141: ONL-mimicking layer

142: ELM-mimicking layer

143: IS-mimicking layer

144: photoreceptor-mimicking layer

145: OS-mimicking layer

146: Verhoeff membrane-mimicking layer

147: RPE-mimicking layer

150: choroid-mimicking layer

151: choroidal channel layer

152: retinal curvature-mimicking layer

160: through-channel

170: sealing layer

180: transparent layer

1000: eye phantom

1200: lens

1300: housing

C1: superficial vascular channels

C2: deep vascular channels

C3: choroidal vascular channels

V: space

P: plate

S: substrate

B: bar

What is claimed is:

1. An eye phantom assembly, comprising:
a nerve fiber layer (NFL)-mimicking layer having superficial vascular channels formed in the form of microchannels to mimic a nerve fiber layer (NFL) among cell layers of retina;
a multilayer membrane-mimicking layer bonded to one surface of the NFL-mimicking layer and having a structure in which multiple layers with different scattering coefficients are stacked to mimic a multilayer cell layer structure of the retina;
an outer plexiform layer (OPL)-mimicking layer bonded to one surface of the multilayer membrane-mimicking layer and having deep vascular channels formed in the form of microchannels to mimic an outer plexiform layer (OPL) among the cell layers of the retina;
an outer membrane-mimicking layer bonded to one surface of the OPL-mimicking layer and formed to mimic an outer cell layer structure of the retina; and
a choroid-mimicking layer bonded to one surface of the outer membrane-mimicking layer and having choroidal vascular channels formed in the form of microchannels to mimic the choroid.

2. The eye phantom assembly of claim 1, further comprising a transparent layer bonded to the other surface of the NFL-mimicking layer.

3. The eye phantom assembly of claim 1, wherein a concave curved portion is formed in a center of the NFL-mimicking layer, the multilayer membrane-mimicking layer, the OPL-mimicking layer, the outer membrane-mimicking layer, and the choroid membrane-mimicking layer.

4. The eye phantom assembly of claim 1, wherein the multilayer membrane-mimicking layer has a structure in which
a ganglion cell layer (GCL)-mimicking layer formed as a film having a scattering coefficient corresponding to that of a ganglion cell layer (GCL) among the cell layers of the retina to mimic the GCL,
an inner plexiform layer (IPL)-mimicking layer formed as a film having a scattering coefficient corresponding to that of an inner plexiform layer (IPL) among the cell layers of the retina to mimic the IPL, and
an inner nuclear layer (INL)-mimicking layer formed as a film having a scattering coefficient corresponding to that of an inner nuclear layer (INL) among the cell layers of the retina to mimic the INL are sequentially stacked.

5. The eye phantom assembly of claim 1, wherein the outer membrane-mimicking layer has a structure in which
an outer nuclear layer (ONL)-mimicking layer formed as a film having a scattering coefficient corresponding to that of an outer nuclear layer (ONL) among the cell layers of the retina to mimic the ONL,
an external limiting membrane (ELM)-mimicking layer formed as a film having a scattering coefficient corresponding to that of an external limiting membrane (ELM) among the cell layers of the retina to mimic the ELM,
an inner segment photoreceptors (IS)-mimicking layer as a film having a scattering coefficient corresponding to that of inner segment photoreceptors (IS) among the cell layers of the retina to mimic the IS,
a photoreceptor-mimicking layer formed as a film having a scattering coefficient corresponding to that of a photoreceptor among the cell layers of the retina to mimic the photoreceptor,
an outer segment photoreceptors (OS)-mimicking layer formed as a film having a scattering coefficient corresponding to that of outer segment photoreceptors (OS) among the cell layers of the retina to mimic the OS,
a Verhoeff membrane-mimicking layer formed as a film having a scattering coefficient corresponding to that of a Verhoeff membrane among the cell layers of the retina to mimic the Verhoeff membrane; and
a retinal pigment epithelium (RPE)-mimicking layer as a film having a scattering coefficient corresponding to that of a retinal pigment epithelium (RPE) among the cell layers of the retina to mimic the RPE are sequentially stacked.

6. The eye phantom assembly of claim 1, wherein the deep vascular channels of the OPL-mimicking layer are formed as honeycomb-shaped channels.

7. The eye phantom assembly of claim 5, wherein the RPE-mimicking layer further comprises a fluorophore.

8. The eye phantom assembly of claim 7, wherein the fluorophore is lipofuscin.

9. The eye phantom assembly of claim 1, further comprising a through-channel that penetrates through the NFL-mimicking layer, the multilayer membrane-mimicking layer, the OPL-mimicking layer, the outer membrane-mimicking layer, and the choroid-mimicking layer to allow a blood-mimicking fluid to flow through the superficial vascular channels, the deep vascular channels, and the choroidal vascular channels.

10. An eye phantom, comprising:
a lens composed of at least one lens to mimic a crystalline lens of an eye;
the eye phantom assembly of claim 1, which is disposed to be spaced apart from the lens along an axis of the lens such that the NFL-mimicking layer faces the lens; and
a housing supporting the lens on one side and supporting the eye phantom assembly on the other side.

11. A method for manufacturing the eye phantom assembly of claim 1, comprising:
a first stacking step of forming a first stack by stacking the NFL-mimicking layer and the multilayer membrane-mimicking layer;
a second stacking step of forming a second stack by stacking the OPL-mimicking layer and the outer membrane-mimicking layer;
a third stacking step of forming a third stack by sequentially stacking the first stack, the second stack, and the choroidal channel stack; and
a fourth stacking step of stacking the retinal curvature-mimicking layer on the lower surface of the choroidal channel layer of the third stack.

12. The method of claim 11, comprising, as a method for fabricating at least one of the NFL-mimicking layer, the OPL-mimicking layer, or the choroidal channel layer having formed therein the choroidal vascular channels of the choroid-mimicking layer:
a light irradiation step of irradiating light for etching to an upper surface of a wafer through a mask having a reverse pattern shape of the shape of the microchannels;
a reverse pattern formation step of forming a reverse pattern on the upper surface of the wafer by etching and removing a light-irradiated portion on the wafer;
a raw material introduction step of introducing a raw material of at least one of the NFL-mimicking layer, the OPL-mimicking layer, or the choroidal channel layer;
a substrate stacking step of stacking and pressing a substrate on an upper surface of the raw material introduced into the reverse pattern;
a wafer separation step of curing the raw material in a state in which a pattern having a reverse shape of the reverse pattern is formed on a lower surface of the raw material and an upper surface of the raw material is adhered to the substrate, and separating the cured raw material from the wafer; and
a substrate separation step of separating the raw material having a pattern of microchannels formed thereon from the substrate.

13. The method of claim 11, comprising, as a method for fabricating at least one of the multilayer membrane-mimicking layer and the outer membrane-mimicking layer:
a substrate upper surface coating step of coating an upper surface of a substrate with a coating agent;
a raw material introduction step of introducing a raw material of at least one of the multilayer membrane-mimicking layer and the outer membrane-mimicking layer to the upper surface of the substrate;
a raw material diffusion step of dispersing the raw material throughout the upper surface of the substrate by rotating the substrate;
a substrate rotation stop step of stopping the rotation of the substrate when the raw material forms a predetermined thickness; and
a film curing step of curing the raw material.

14. The method of claim 13, further comprising a mimicking layer formation step of forming multiple stacks having different scattering coefficients on the upper surface of the substrate by sequentially repeating the raw material introduction step, the raw material diffusion step, the substrate rotation stop step, and the film curing step.

15. The method of claim 14, wherein the raw material diffusion step comprises varying the rotation speed of the substrate so that at least one of the plurality of multilayer membrane-mimicking layers and outer membrane-mimicking layers has a different thickness.

16. The method of claim 13, further comprising a substrate preparation step of preparing a wafer substrate.

17. The method of claim 12, comprising, as a method for fabricating the retinal curvature-mimicking layer, which is a portion of the choroid--mimicking layer excluding the choroidal channel layer:
a plate preparation step of preparing a plate by forming a convex curved portion in a center of a flat plate formed in an engraved shape;
a raw material introduction and curing step of introducing a raw material of the retinal curvature-mimicking layer into the plate and curing the raw material; and
a plate separation step of separating the raw material of the retinal curvature-mimicking layer from the plate.

18. The method of claim 17, wherein the plate preparation step comprises forming a concave curved portion in a direction opposite to the convex curved portion at a portion where one surface of the plate formed in the engraved shape and the convex curved portion contact each other.

19. The method of claim 17, wherein the plate preparation step comprises forming protrusions, which serve as a predetermined reference point, on one surface of the plate formed in the engraved shape.

20. The method of claim 11, comprising a pressing step of pressing the center of the eye phantom assembly.
